(19) United States
(12) Patent Application Publication
(10) Pub. No.: US 2018/0357342 A1
(43) Pub. Date: Dec. 13, 2018

(54) STATE PREDICTION DEVICE, STATE PREDICTION METHOD AND NON-TRANSITORY RECORDING MEDIUM STORING COMPUTER-READABLE STATE PREDICTION PROGRAM

(71) Applicant: Konica Minolta, Inc., Tokyo (JP)

(72) Inventors: Toshimichi Iwai, Nara-ken (JP); Yoshikazu Ikenoue, Hyogo-ken (JP); Hirokazu Kubota, Shiga-ken (JP)

(73) Assignee: Konica Minolta, Inc., Tokyo (JP)

(21) Appl. No.: 16/003,852

(22) Filed: Jun. 8, 2018

(30) Foreign Application Priority Data
Jun. 8, 2017 (JP) 2017-113445

(51) Int. Cl. G06F 17/50

(52) U.S. Cl. CPC G06F 17/5009

(57) ABSTRACT

A state prediction device includes a hardware processor. The hardware processor simulates an information processing apparatus in operation with a virtual device, increases a load on a virtual device to a load larger than a load on the information processing apparatus by causing a virtual device to process a data piece. The data piece is generated with a larger data amount than that of a second data piece received externally by the information processing apparatus. The hardware processor also determines whether an allowing condition, preset in the information processing apparatus, is unsatisfied by an operation state of the virtual device while the increased load is applied.

### CROSS-REFERENCE TO RELATED APPLICATIONS

The present application claims priority under 35 U.S.C. § 119 to Japanese Patent Application No. 2017-113445 filed on Jun. 8, 2017. The content of this application is herein incorporated by reference in their entirety.

### TECHNOLOGICAL FIELD

The present invention relates to a state prediction device, a state prediction method and a non-transitory computer-readable recording medium storing a state prediction program. In particular, the present invention relates to a state prediction device that predicts an operation state of an information processing apparatus by simulating the communicable information processing apparatus, a state prediction method performed in the state prediction device and a non-transitory computer-readable recording medium storing a state prediction program executed by a computer controlling the state prediction device.

### BACKGROUND

For example, Japan Open-laid Patent No. H07-58760 describes a performance prediction method of predicting an influence on a network system using a network simulator that simulates an operation of the network system when a new application means is added to the network system in an operation state, wherein the performance prediction method is characterized in importing a transmission frame row transmitted and received via a transmission path in the operation state together with a reception time point, extracting a command frame based on a correspondence relationship of a command-response frame defined by a communication step used in the network system from the imported transmission frame row, locating a response frame corresponding to the command frame, generating command-response characteristics information including variations in command-response characteristics between respective nodes in the operation state by updating the command-response characteristics information between the respective nodes with a difference between reception time points of the response frame and the command frame used as a response time period, and using the command-response characteristic information as load data of the transmission path in an actual operation state in the case where predicting using the network simulator. Because the command-response characteristics information is used in the prediction using the network simulator described in Japan Open-laid Patent No. H07-58760, performance of the network system after the application means is added can be predicted based on the data that is actually transmitted and received.

Generally, the data piece to be processed by the device is predetermined, the program installed in the device is designed to be able to process the data. On the other hand, in the case where the device is connected to a network, the data received from another device may not be guaranteed to be compatible with the program installed in the device. In the case where processing the data that is not guaranteed to be compatible with the program, the device may not be able to be process the data successfully. In this case, a load on the Central Processing Unit (CPU) that executes the program is increased, and the driving may be stopped in the worst case.

### SUMMARY

According to one aspect of one or more embodiments of the present invention, a state prediction device comprising a hardware processor, wherein the hardware processor simulates an information processing apparatus in operation, increases a load on a virtual device to a load larger than a load on the information processing apparatus by causing the virtual device simulating the information processing apparatus to process a data piece, the data piece being generated such that a data amount of the data piece becomes larger than that of a data piece received externally by the information processing apparatus, and determines whether an allowing condition that is preset in the information processing apparatus is unsatisfied by an operation state of the virtual device on which the increased load is applied.

According to another aspect of one or more embodiments of the present invention, a state prediction method is performed by a state prediction device, the state prediction method causing the state prediction device to simulate an information processing apparatus in operation, increase a load on a virtual device to a load larger than a load on the information processing apparatus by causing the virtual device simulating the information processing apparatus to process a data piece, the data piece being generated such that a data amount of the data piece becomes larger than that of a data piece received externally by the information processing apparatus, and determine whether an allowing condition preset in the information processing apparatus is unsatisfied by an operation state of the virtual device on which an increased load is applied.

According to yet another aspect of one or more embodiments of the present invention, a non-transitory computer-readable recording medium storing a state prediction program is executed by a computer controlling a state prediction device, the state prediction program causing the computer to simulate an information processing apparatus in operation, increase a load on the virtual device to a load larger than a load on the information processing apparatus by causing a virtual device simulating the information processing apparatus to process a data piece, the data piece being generated such that a data amount of the data piece becomes larger than that of a data piece received externally by the information processing apparatus and determine whether an allowing condition preset in the information processing apparatus is unsatisfied by an operation state of the virtual device on which an increased load is applied.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram showing one example of an overview of an information processing system in one or more embodiments of the present invention;

FIG. 2 is a block diagram showing one example of an outline of a hardware configuration of a server according to one or more embodiments;

FIG. 3 is a block diagram showing one example of an outline of a hardware configuration of an MFP according to one or more embodiments;

FIG. 4 is a block diagram showing one example of a detailed configuration of a main board according to one or more embodiments;

FIG. 5 is a diagram showing one example of an outline of a simulator included in the server according to one or more embodiments;

FIG. 6 is a block diagram showing one example of functions of a CPU included in the MFP according to one or more embodiments;

FIG. 7 is a block diagram showing one example of functions of a CPU included in the server according to one or more embodiments;

FIG. 8 is a flow chart showing one example of a flow of a state notification process according to one or more embodiments;

FIG. 9 is a flow chart showing one example of a flow of a state prediction process according to one or more embodiments;

FIG. 10 is a block diagram showing one example of functions of a CPU included in an MFP according to one or more embodiments;

FIG. 11 is a block diagram showing one example of functions of a CPU included in a server according to one or more embodiments; and

FIG. 12 is a flow chart showing one example of a flow of an operation assistance process according to one or more embodiments.

### DETAILED DESCRIPTION

Embodiments of the present invention will be described below with reference to the drawings. In the following description, the same parts are denoted with the same reference characters. Their names and functions are also the same. Thus, a detailed description thereof will not be repeated.

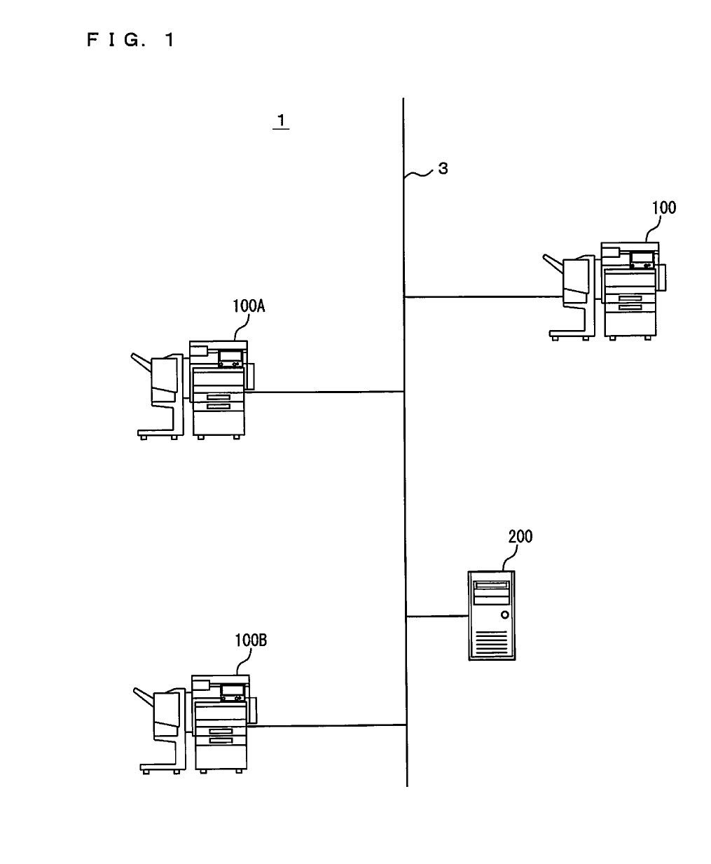

FIG. 1 is a diagram showing one example of an overview of an information processing system according to one or more embodiments of the present invention. Referring to FIG. 1, the information processing system 1 includes MFPs (Multi Function Peripherals) 100, 100A, 100B and a server 200.

The MFPs 100, 100A, 100B are one example of an image forming apparatus, and includes at least an image forming function of forming an image on a recording medium such as a sheet of paper based on image data. In addition to the image forming function, the MFPs 100, 100A, 100B may include a document scanning function of scanning a document and a facsimile transmission reception function of transmitting and receiving facsimile data. The server 200 is a general computer.

The server 200 and the MFPs 100, 100A, 100B are respectively connected to a network 3. The network 3 is a Local Area Network (LAN), either wired or wireless. The network 3 may further be connected to the Internet. In this case, the server 200 and the MFPs 100, 100A, 100B can respectively communicate with the computer connected to the Internet via the network 3. Further, the network 3 is not limited to a LAN and may be a network using Public Switched Telephone Networks. Further, the network 3 may be a Wide Area Network (WAN) such as the Internet.

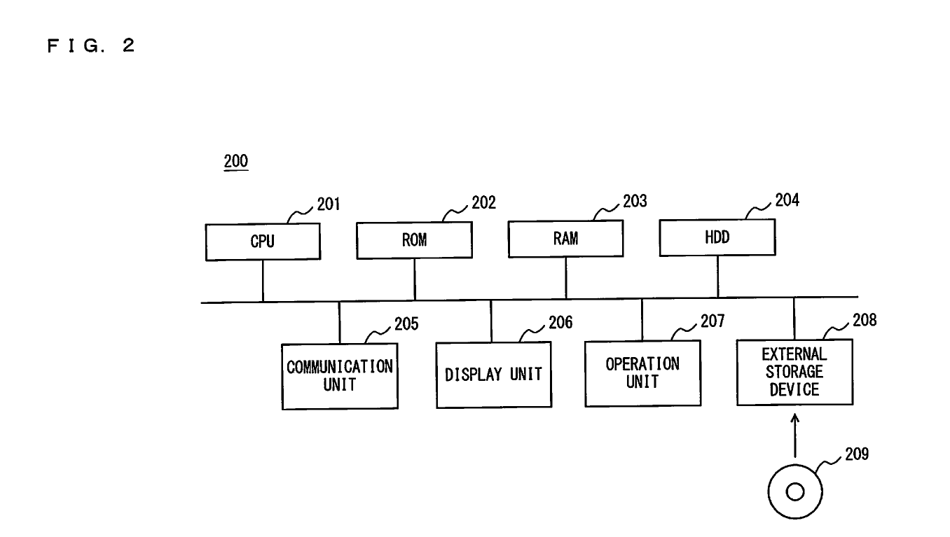

FIG. 2 is a block diagram showing one example of an outline of a hardware configuration of a server according to one or more embodiments. Referring to FIG. 2, the server 200 includes a hardware processor or Central Processing Unit (CPU) 201 for controlling the server 200 as a whole, a ROM (Read Only Memory) 202 for storing a program to be executed by the CPU 201, a RAM (Random Access Memory) 203 that is used as a work area of the CPU 201, a Hard Disc Drive (HDD) 204 that stores data in a non-volatile manner, a communication unit 205 that connects the CPU 201 to the network 3, a display unit 206 that displays information, an operation unit 207 that accepts an input operation by a user and an external storage device 208.

The display unit 206 is a display device such as a Liquid Crystal Display (LCD) device and an organic ELD (Electro-Luminescence Display). The operation unit 207 is hard keys such as a keyboard. Further, the operation unit 207 may be a touch panel. The touch panel is superimposed on an upper or lower surface of the display unit 206. The touch panel detects the position designated by the user in a display surface of the display unit 206.

The communication unit 205 is an interface for connecting the CPU 201 to the network 3. The communication unit 205 communicates with the MFPs 100, 100A, 100B connected to the network using a communication protocol such as a TCP (Transmission Control Protocol) or a UDP (User Datagram Protocol). The protocol for communication is not limited in particular, and any protocol can be used. When IP (Internet Protocol) addresses of the respective MFPs 100, 100A, 100B are registered in the server 200, the server 200 can communicate with the respective MFPs 100, 100A, 100B and can transmit and receive data.

The HDD 204 stores the program executed by the CPU 201 and the data necessary for the execution of the program. The CPU 201 loads the program recorded in the HDD 204 into the RAM 203 for execution.

The external storage device 208 is mounted with a CD-ROM (Compact Disk ROM) 209 storing a program. The CPU 201 is capable of accessing the CD-ROM 209 via the external storage device 208. The CPU 201 loads the program, recorded in the CD-ROM 209 which is mounted on the external storage device 208, into the RAM 203 for execution. It is noted that the medium for storing the program executed by the CPU 201 is not limited to the CD-ROM 209. It may be an optical disc (MO (Magnetic Optical Disc)/MD (Mini Disc)/DVD (Digital Versatile Disc)), an IC card, an optical card, and a semiconductor memory such as a mask ROM and an EPROM (Erasable Programmable ROM).

Further, the program executed by the CPU 201 is not limited to a program recorded in the CD-ROM 209, and the CPU 201 may load a program, stored in the HDD 204, into RAM 203 for execution. In this case, another computer connected to the network 3 may rewrite the program stored in the HDD 204, or may additionally write a new program therein. Further, the server 200 may download a program from another computer connected to the network 3 or the Internet, and store the program in the HDD 204. The program referred to here includes not only a program directly executable by the CPU 201 but also a source program, a compressed program, an encrypted program or the like.

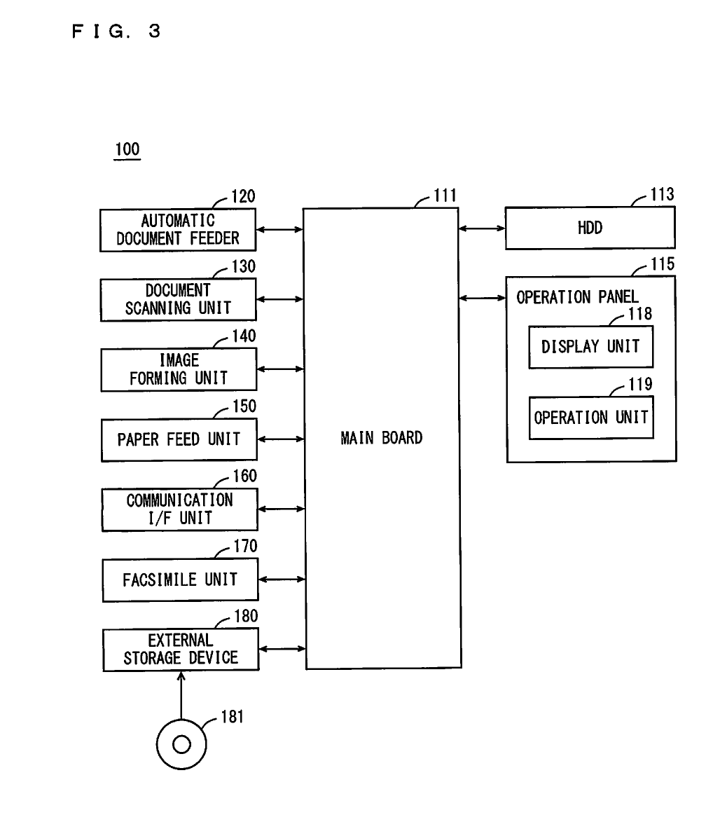

Since the hardware configuration and functions of the MFPs 100, 100A, 100B are the same, the MFP 100 is described here as an example. FIG. 3 is a block diagram showing one example of the outline of the hardware configuration of the MFP according to one or more embodiments. Referring to FIG. 3, the MFP 100 includes a main board 111, a document scanning unit 130 for scanning a document, an automatic document feeder 120 for conveying a document to the document scanning unit 130, an image forming unit 140 for forming an image on a sheet of paper or other medium based on image data output by the document scanning unit 130 that has scanned a document, a paper feed unit 150 for supplying sheets of paper to the image forming unit 140, a communication interface (I/F) unit 160, a facsimile unit 170, an external storage device 180, a hard disc drive (HDD) 113 as a mass storage device and an operation panel 115 serving as a user interface.

The main board 111 is connected to the automatic document feeder 120, the document scanning unit 130, the image forming unit 140 and the paper feed unit 150, the communication I/F unit 160, the facsimile unit 170, the external storage device 180, the HDD 113 and the operation panel 115, and controls the entire MFP 100.

The automatic document feeder 120 automatically transports a plurality of documents set on a document feed tray to a predetermined document scanning position set on a platen glass of the document scanning unit 130 one by one, and discharges the document, the image of which has been scanned by the document scanning unit 130, onto a document discharge tray. The document scanning unit 130 includes a light source that irradiates the document that has been transported to the document scanning position with light, and an optoelectronic transducer that receives the light reflected by the document and scans the document image according to a size of the document. The optoelectronic transducer converts the received light into image data, which is an electric signal, and outputs the image data to the image forming unit 140.

The paper feed unit 150 conveys sheets of paper stored in the paper feed tray to the image forming unit 140. The image forming unit 140 forms an image by a well-known electrophotographic method. The image forming unit 140 forms an image on the sheet of paper that has been conveyed by the paper feed unit 150, based on the processed image data obtained when various data processing such as shading correction is performed on the image data received from the document scanning unit 130 or the externally received image data, and discharges the sheet of paper having an image formed thereon to the discharge tray.

The communication I/F unit 160 is an interface for connecting the MFP 100 to the network 3. The communication I/F unit 160 communicates with another computer connected to the network using a communication protocol such as a TCP or a UDP. The protocol for communication is not limited in particular, and any protocol can be used.

The communication I/F unit 160 outputs the data received from the network 3 to the main board 111, and outputs the data received from the main board 111 to the network 3. The communication I/F unit 160 outputs only the data, that is addressed to the MFP 100 out of the data received from the network 3, to the main board 111, and discards the data addressed to a device different from the MFP 100 out of the data received from the network 3.

The facsimile unit 170 is connected to the Public Switched Telephone Networks (PSTN), and transmits and receives facsimile data. The external storage device 180 is mounted with a CD-ROM 181 or a semiconductor memory. The external storage device 180 reads out the data stored in the CD-ROM 181 or the semiconductor memory. The external storage device 180 stores the data in the CD-ROM 181 or the semiconductor memory.

The operation panel 115 is provided on an upper surface of the MFP 100, and includes the display unit 118 and the operation unit 119. The display unit 118 is a display device such as a Liquid Crystal Display (LCD) device or an organic ELD, and displays instruction menus to users, information about the acquired image data, and the like. The operation unit 119 includes a plurality of hard keys and a touch panel. The touch panel is a multi-touch-capable panel superimposed on an upper or lower surface of the display unit 118 and detects the position designated by the user in the display surface of the display unit 118.

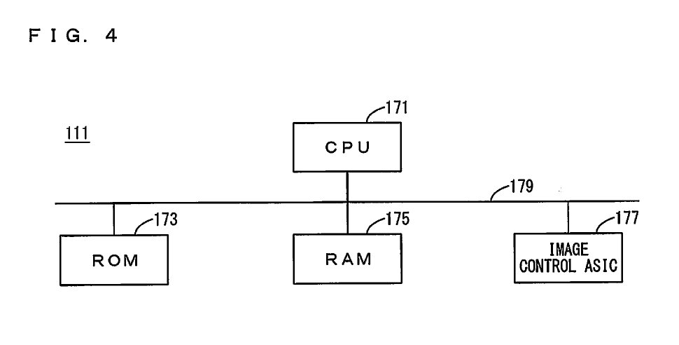

FIG. 4 is a block diagram showing one example of a detailed configuration of the main board according to one or more embodiments. Referring to FIG. 4, the main board 111 includes a CPU 171, a ROM 173, a RAM 175 and an image control ASIC (Application Specific Integrated Circuit) 177.

The CPU 171, the ROM 173, the RAM 175 and the image control ASIC 177 are respectively connected to a bus 179 and can transfer data. The CPU 171 controls the entire MFP 100. The ROM 173 stores the program executed by the CPU 171. The RAM 175 is a volatile semiconductor memory that is used as a work area of the CPU 171.

The CPU 171 loads the program stored in the HDD 113 into the RAM 175 for execution. The program executed by the CPU 171 includes a control program for controlling hardware resources and an application program. The hardware resources include the automatic document feeder 120, the document scanning unit 130, the image forming unit 140, the paper feed unit 150, the communication I/F unit 160, the facsimile unit 170, the HDD 113 and the operation panel 115. The application program includes a facsimile transmission program for controlling the facsimile unit 170 and transmitting facsimile data, a facsimile reception program for controlling the facsimile unit 170 and receiving facsimile data, a print program for controlling the communication I/F unit 160 and receiving a print job, and controlling the image forming unit 140 and the paper feed unit 150 and forming an image based on the print job, and a document scanning program for controlling the document scanning unit 130 and scanning a document, for example. Further, the application program may include a maintenance program for managing consumables included in the MFP 100 and an error state notification program for making notification of an error state. The application program executed by the CPU 171 is not limited to these.

The image control ASIC 177 is connected to and controls the automatic document feeder 120, the document scanning unit 130, the image forming unit 140 and the paper feed unit 150. Further, the image control ASIC 177 has a function of executing predetermined image processing and processing the image data output by the document scanning unit 130 that has scanned a document, and a function of converting the image data into raster data for printing by the image forming unit 140.

In accordance with one or more embodiments, the server 200 includes a simulator that simulates the MFPs 100, 100A, 100B. Since the server 200 simulates the respective MFPs 100, 100A, 100B in the same manner, the case where the server 200 simulates the MFP 100 will be described here as an example.

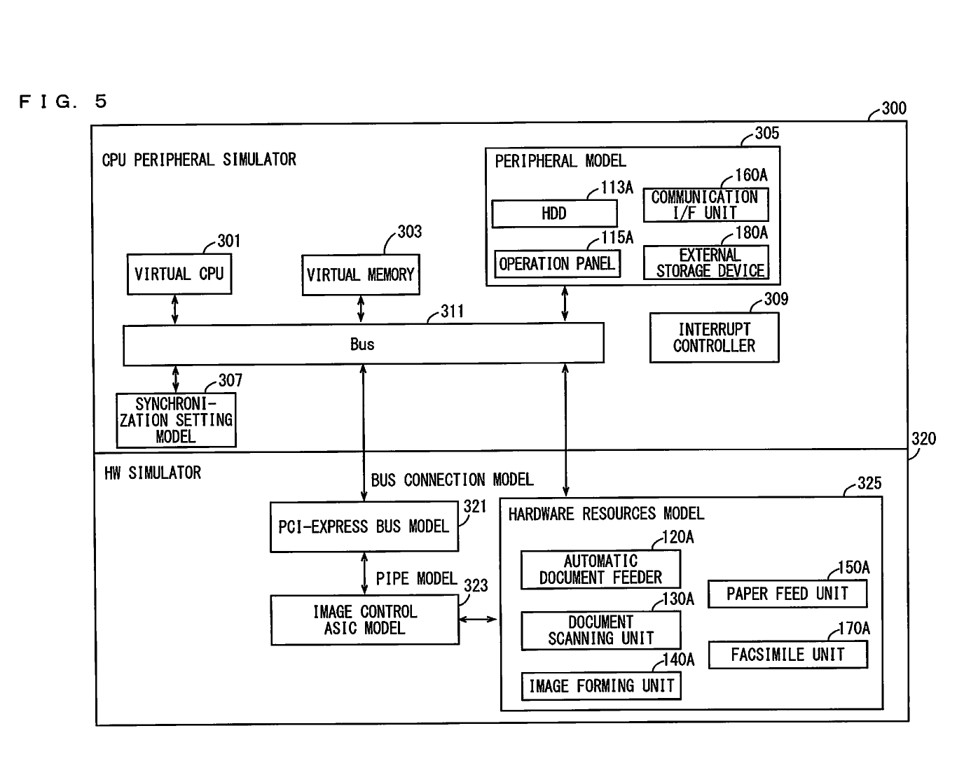

FIG. 5 is a diagram showing one example of an outline of the simulator included in the server according to one or more embodiments. This simulator is formed in the CPU 201 when the CPU 201 executes a simulate program. Referring to FIG. 5, the simulator includes a CPU peripheral simulator 300 and a hardware (HW) simulator 320. The CPU peripheral simulator 300 includes a virtual CPU 301 that simulates the CPU 171 included in the MFP 100, a virtual memory 303 that emulates the ROM 173 and the RAM 175, a peripheral model 305, a synchronization setting model 307 and an interrupt controller 309. The virtual CPU 301, the virtual memory 303, the peripheral model 305 and the synchronization setting model 307 are connected to a Bus 311.

The peripheral model 305 includes an HDD 113A, an operation panel 115A, a communication I/F unit 160A and an external storage device 180A that emulate the HDD 113, the operation panel 115, the communication I/F unit 160 and the external storage device 180 that are included in the MFP 100, respectively.

The synchronization setting model 307 makes settings such that the virtual CPU 301 synchronizes with the virtual memory 303 and the peripheral model 305. When the settings are made in order for the virtual CPU 301 to synchronize with the virtual memory 303 and the peripheral model 305, the interrupt controller 309 generates an interrupt in the virtual CPU 301.

The HW simulator 320 includes a PCI-Express Bus model 321 and an image control ASIC model 323 and a hardware resources model 325. The PCI-Express Bus model 321 is connected to the bus 311 and emulates the connection in accordance with the PCI-Express standard. The image control ASIC model 323 emulates the image control ASIC 177 included in the MFP 100. The hardware resources model 325 emulates the hardware resources included in the MFP 100. Specifically, the hardware resources model 325 includes an automatic document feeder 120A, a document scanning unit 130A, an image forming unit 140A, a paper feed unit 150A and a facsimile unit 170A that emulate the automatic document feeder 120, the document scanning unit 130, the image forming unit 140, the paper feed unit 150 and the facsimile unit 170 that are included in the MFP 100, respectively.

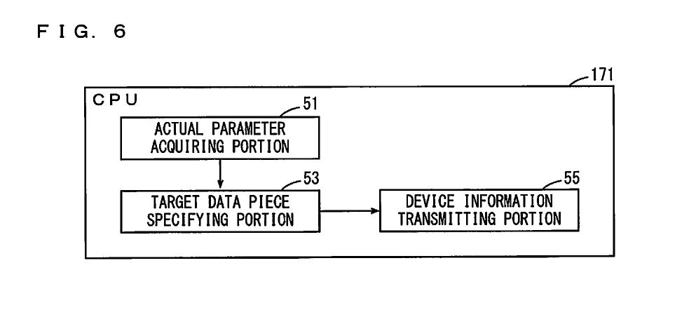

FIG. 6 is a block diagram showing one example of functions of the CPU included in the MFP according to one or more embodiments. The functions shown in FIG. 6 are implemented by the CPU 171 when the CPU 171 included in the MFP 100 executes a state notification program stored in the ROM 173, the HDD 113 or the CD-ROM 181. The state notification program is part of a state prediction program. Referring to FIG. 6, the CPU 171 includes an actual parameter acquiring portion 51, a target data piece specifying portion 53 and a device information transmitting portion 55.

The actual parameter acquiring portion 51 acquires an actual parameter indicating a load on the CPU 171 for each job executed by the CPU 171. The actual parameter is a value defined for each job. Specifically, the actual parameter indicates a load on the CPU 171 in the case where the CPU 171 executes a process defined by the job and processes the data piece to be processed in the job. Therefore, the actual parameter is the value corresponding to the data piece to be processed in the job. Here, the actual parameter is a utilization rate of the CPU 171. The utilization rate of the CPU 171 is the proportion of the time required for the CPU 171 to execute a task of executing a job. The actual parameter is not limited to the utilization rate of the CPU 171 and may be a value defined for the data piece to be processed in a job. For example, a utilization rate of the RAM 175 and the number of times of swaps in which a data piece is transferred between swap regions of the RAM 175 and the HDD 113 may be used as the actual parameter. The actual parameter acquiring portion 51 outputs the actual parameter acquired for each job to the target data piece specifying portion 53.

The target data piece specifying portion 53 specifies the data piece, that is predicted to increase a load on the CPU 171, as a target data piece. Specifically, the target data piece specifying portion 53 specifies the data piece to be processed in a process that causes the actual parameter to be in a predetermined prediction state, as the target data piece. Here, the target data piece specifying portion 53 compares the actual parameter to a predetermined threshold value. In the case where the job that causes the actual parameter to be equal to or larger than the threshold value is present, the target data piece specifying portion 53 specifies the data piece to be processed in the job as the data piece that is predicted to increase a load on the CPU 171. Further, the target data piece specifying portion 53 specifies the data piece as the target data piece on the condition that the data piece predicted to increase a load on the CPU 171 is the data piece that has been received from an external device. The target data piece specifying portion 53 outputs the specified job and the target data piece to the device information transmitting portion 55.

The threshold value is a predetermined value of a load on the CPU 171. The threshold value is a value at which an error does not occur in each of all of the tasks executed by the CPU 171. For example, the utilization rate of the CPU 171 is sometimes increased in the case where the same process is unnecessarily and repeatedly executed in a certain task. The threshold value may be a value at which unnecessary repetitive execution of the same process by the CPU 171 can be detected. In this case, the threshold value is defined by the task of executing a job. The threshold value may be an increase rate of the utilization rate of the CPU 171. Further, when the utilization rate of the CPU 171 for a first task is increased, the utilization rate of the CPU 171 for a second task is lowered relatively. In this case, there may be a delay with the process of the second task, and a time-out error or the like may occur. The threshold value may be a value at which the state of the CPU 171 in the first task can be detected before the time-out error occurs in the process of the second task. In this case, the threshold value is defined by a relative relationship with another task of executing another job. An upper limit of the utilization rate of the CPU 171 allowed for one task 171 may be predetermined as the threshold value. This threshold value can be obtained by an experiment.

The target data piece specified by the target data piece specifying portion 53 is the data piece that has been received from an external device. An error may occur when the CPU 171 continues to process the target data piece. The data piece received from the external device includes the data piece that has been received from an external device and has been stored in the HDD 113. The program executed by the CPU 171 is designed to be able to process the data piece that is generated by the MFP 100 such as the data piece that is output by the document scanning unit 130 that has scanned a document. This is because the program for controlling the document scanning unit 130 and the program for processing the data piece output by the document scanning unit 130 are designed to be compatible with each other. On the other hand, the program executed by the CPU 171 may not be designed to be compatible with the data piece received from an external device. For example, the program is sometimes not compatible with a format of the externally received data piece.

The device information transmitting portion 55 generates device information including the job and the target data piece that are received from the target data piece specifying portion 53, and controls the communication I/F unit 160 to transmit the generated device information to the server 200. The device information includes a model name of the CPU 171 provided in the MFP 100, hardware information relating to the hardware resources installed in the MFP 100, software information relating to the software resources installed in the MFP 100, and device information including setting values set in the MFP 100, a job and a target data piece received from the target data piece specifying portion 53.

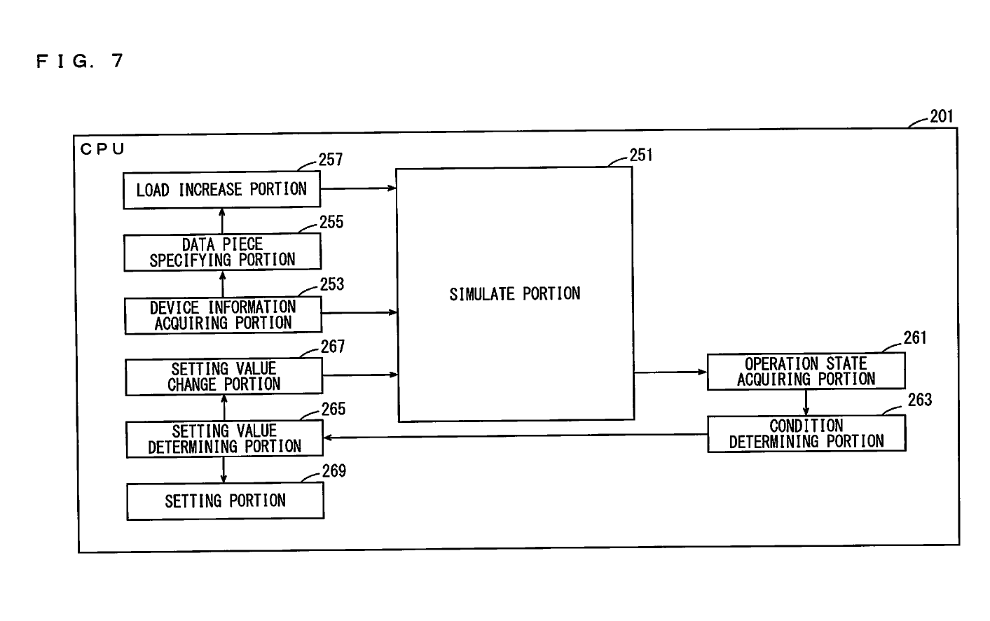

FIG. 7 is a block diagram showing one example of functions of the CPU included in the server according to one or more embodiments. The functions shown in FIG. 7 are implemented by the CPU 201 when the CPU 201 included in the server 200 executes the state prediction program stored in the ROM 202, the HDD 204 or the CD-ROM 210A.

Referring to FIG. 7, the CPU 201 included in the server 200 includes a simulate portion 251, a device information acquiring portion 253, a data piece specifying portion 255, a load increase portion 257, an operation state acquiring portion 261, a condition determining portion 263, a setting value determining portion 265, a setting value change portion 267 and a setting portion 269.

The device information acquiring portion 253 acquires device information from any one of the MFPs 100, 100A, 100B. As described above, in the case where a job that increases a load on the CPU 171 is generated, any one of the MFPs 100, 100A, 100B transmits the device information including a job and a target data piece. When the communication unit 205 receives the device information from any one of the MFPs 100, 100A, 100B, the device information acquiring portion 253 acquires the device information that has been received by the communication unit 205. The case where the device information is acquired from the MFP 100 will be described here as an example. In the case where the device information acquiring portion 253 acquires the device information from the MFP 100, the MFP 100 is set to be monitored. The device information includes a model name of a Central Processing Unit provided in the device, the hardware information relating to the hardware resources installed in the device, the software information relating to the software resources installed in the device, a setting value, a job under execution in the device and the target data piece. The setting value influences the load of the task executed by the CPU 171 included in the MFP 100 that is to be monitored. For example, the setting value defines a priority order of execution of a plurality of tasks. In the case where acquiring the device information, the device information acquiring portion 253 outputs the device information to the simulate portion 251 and the data piece specifying portion 255.

The simulate portion 251 simulates the MFP 100 that is to be monitored based on the device information received from the device information acquiring portion 253. The simulate portion 251 makes settings of the hardware resources mounted on the MFP 100 that is to be monitored, causes the virtual CPU 301 to run the software resources run by the CPU 171 of the MFP 100, sets the setting value and causes the virtual CPU 301 to execute the job under execution by the CPU 171 of the MFP 100.

The MFP 100 includes the image control ASIC 177, the automatic document feeder 120, the document scanning unit 130, the image forming unit 140, the paper feed unit 150, the communication I/F unit 160, the facsimile unit 170, the external storage device 180, the HDD 113 and the operation panel 115 as hardware resources. Therefore, the hardware information included in the device information defines the image control ASIC 177, the automatic document feeder 120, the document scanning unit 130, the image forming unit 140, the paper feed unit 150, the communication I/F unit 160, the facsimile unit 170, the external storage device 180, the HDD 113 and the operation panel 115 as the hardware resources. The simulate portion 251 makes settings of the emulator that respectively emulates the image control ASIC 177, the automatic document feeder 120, the document scanning unit 130, the image forming unit 140, the paper feed unit 150, the communication I/F unit 160, the facsimile unit 170, the external storage device 180, the HDD 113 and the operation panel 115 that are defined by the hardware information included in the device information. Further, the simulate portion 251 makes settings such that the virtual CPU 301 is synchronized with the emulator of the hardware resources in the MFP 100. For example, the simulate portion 251 causes the synchronization setting model 307 of the CPU peripheral simulator 300 shown in FIG. 6 to make settings of a register value of the virtual CPU 301 such that the virtual CPU 301 is synchronized with the emulator of the hardware resources, and rewrites a memory map of the virtual memory 303.

Further, the simulate portion 251 sets the software resources, defined by the software information included in the device information, in a state where the software resources are run by the virtual CPU, and sets the setting value included in the device information. Specifically, the simulate portion 251 installs the software resources defined by the software information included in the device information, and sets the setting value included in the device information. Thus, in the simulate portion 251, a virtual device that is the simulation of the MFP 100 is completed. The data stored in the RAM 175 of the MFP 100 may be acquired as a snapshot and stored in the virtual memory 303.

In response to reception of the device information from the device information acquiring portion 253, the data piece specifying portion 255 specifies the job and the target data piece included in the device information, and outputs the job and the target data piece to the load increase portion 257.

In response to reception of the job and the target data piece from the data piece specifying portion 255, the load increase portion 257 causes the virtual CPU 301 to process the target data piece with the load that is applied when the target data piece is processed by the virtual CPU 301 of the virtual device being larger than the load that is applied when the target data piece is processed by the CPU 171 of the MFP 100, the virtual device including the simulate portion 251 that simulates the MFP 100 that is to be monitored. Specifically, the data amount of the target data piece corresponding to the job is increased, so that the load that is applied by the task when the virtual CPU 301 executes the job is increased. The load increase portion 257 increases the data amount of the target data piece by an amount defined by a predetermined increase rate. The load increase portion 257 may increase the data amount of the target data piece by adding the part corresponding to the data amount defined by the increase rate of the target data piece to the target data piece. It is necessary that an error occurs in the virtual CPU 301 before the MFP 100 that is to be monitored continues to process the target data piece and causes an error to occur. Therefore, the relationship between the data amount and an increase amount of the load on the virtual CPU 301 may be obtained by an experiment, and an increase rate of the target data piece may be defined in relation to an allowing condition, described below. Here, the increase rate is 200%, and the data amount of the target data piece is doubled.

In the case where the data amount of the target data piece is increased by the load increase portion 257, the simulate portion 251 causes the virtual CPU 301 to execute the job received from the data piece specifying portion 255. Specifically, the simulate portion 251 causes the virtual CPU 301 of the virtual device to perform the process defined by the job on the target data piece of which the data amount is increased by the load increase portion 257. The simulate portion 251 executes only the job corresponding to the target data piece. Because the change of the load on the virtual CPU 301 in the job corresponding to the target data piece can be observed, whether the load on the virtual CPU 301 is increased due to the target data piece can be detected early.

Because simulating the MFP 100 in response to reception of the device information by the device information acquiring portion 253 from any one of the MFPs 100, 100A, 100B, for example, the MFP 100, the simulate portion 251 does not simulate the MFP 100 until the device information acquiring portion 253 receives the device information from the MFP 100. Therefore, the load on the CPU 201 of the server 200 can be reduced as much as possible.

The MFP 100 may transmit the device information including all of the jobs executed in the MFP 100, and the simulate portion 251 may cause the virtual device to execute all of the jobs executed in the MFP 100. In this case, the case where an increase in load on the virtual CPU 301 in the job corresponding to the target data piece is caused by a relative relationship between the job corresponding to the target data piece and the job other than the job corresponding to the target data piece may be covered.

The job and the target data piece received from the data piece specifying portion 255 are received in the communication I/F unit 160. Therefore, the simulate portion 251 causes the emulator that emulates the communication I/F unit 160 to receive the job. Further, when causing the emulator that emulates the communication I/F unit 160 to receive the job and the target data piece, the simulate portion 251 increases the data amount to be received per unit time by the emulator. Thus, a time period required to receive the target data piece can be shortened.

The operation state acquiring portion 261 acquires an operation state of the virtual device from the simulate portion 251 that performs the process defined by the job on the target data piece of which the data amount has been increased. The operation state of the virtual device is a load on the entire virtual CPU 301. Here, the operation state of the virtual device is the utilization rate of the virtual CPU 301. The operation state of the virtual device is not limited to the utilization rate of the virtual CPU 301, but the utilization rate of the virtual memory 303 and the number of swaps in which the data piece is transferred between the virtual memory 303 and the swap region of the HDD 113A may be used. Further, the operation state acquiring portion 261 may acquire a response time from the start to the end of the execution of a certain process as an operation state. For example, the operation state acquiring portion 261 supplies an input operation by a predetermined user to the simulate portion 251, and measures a time period from the time when the input operation by the user is accepted in the operation panel 115A until the time when a screen is displayed as a response time period. The operation state acquiring portion 261 outputs the acquired operation state to the condition determining portion 263.

The condition determining portion 263 determines whether the allowing condition that is preset in the MFP 100 that is to be monitored is unsatisfied by the operation state of the virtual device received from the operation state acquiring portion 261. In the case where the allowing condition is unsatisfied by the operation state of the virtual device, the condition determining portion 263 outputs an error signal to the setting value determining portion 265. In the case where the allowing condition is satisfied by the operation state of the virtual device, the condition determining portion 263 outputs a normal signal to the setting value determining portion 265. The allowing condition that is preset in the MFP 100 that is to be monitored can be that the utilization rate of the CPU 171 included in the MFP 100 is equal to or lower than an upper limit value. Further, even in the case where the utilization rate of the CPU 171 included in the MFP 100 exceeds the upper limit value, the allowing condition may be satisfied as long as the utilization rate does not exceed the upper limit value continuously for a predetermined time period. In the case where the utilization rate of the CPU 171 exceeds the upper limit value continuously for a time period equal to or longer than the predetermined time period, the condition determining portion 263 determines that the allowing condition is unsatisfied by the operation state of the virtual device, and outputs the error signal to the setting value determining portion 265. If the utilization rate of the CPU 171 does not exceed the upper limit value continuously for the predetermined time period, the condition determining portion 263 determines that the allowing condition is satisfied by the operation state of the virtual device, and outputs the normal signal to the setting value determining portion 265.

In response to reception of the error signal from the condition determining portion 263, the setting value determining portion 265 outputs a change instruction to the setting value change portion 267. In response to reception of the normal signal after receiving the error signal from the condition determining portion 263, the setting value determining portion 265 determines on the setting value that is set at that time point, and outputs the determined setting value to the setting portion 269.

The setting value change portion 267 changes the setting value set in the simulate portion 251. The setting value referred here influences the load of the task executed by the virtual CPU 301. For example, the setting value defines the priority order of the execution of a plurality of tasks. Further, the setting value may be a time-out period set for the control of the hardware resources, or the like. Further, the setting value may be the size of the work area of the virtual memory 303. Further, the setting value may be the size of a swap region of each of the virtual memory 303 and the HDD 113A.

In the case where the setting value is changed by the setting value change portion 267, the simulate portion 251 causes the virtual device to perform the process defined by the job on the target data piece of which the data amount is increased in accordance with the changed setting value. Thus, the operation state acquiring portion 261 acquires an operation state of the virtual device from the simulate portion 251, and the condition determining portion 263 determines whether the allowing condition is satisfied by the operation state of the virtual device. The setting value change portion 267 changes the setting value to various values until the condition determining portion 263 determines that the allowing condition is satisfied by the operation state of the virtual device, and the simulate portion 251 causes the virtual device to execute the process in accordance with the changed setting value.

In the case where the condition determining portion 263 determines that the allowing condition is unsatisfied by the operation state of the virtual device, and then determines that the allowing condition is satisfied by the operation state of the virtual device, the setting value determining portion 265 determines the setting value, and outputs the determined setting value to the setting portion 269.

In response to reception of the setting value from the setting value determining portion 265, the setting portion 269 causes the MFP 100 that is to be monitored to set the setting value. Specifically, the setting portion 269 controls the communication unit 205 and transmits the command of setting the setting value received from the setting value determining portion 265 to the MFP 100. It is confirmed by the simulation carried out by the simulate portion 251 that the allowing condition is satisfied by the operation state of the virtual CPU 301 with the setting value set to the setting value determined by the setting value determining portion 265. Thus, the job can be continuously executed with the allowing condition satisfied in the MFP 100. In the case where the hardware resources and the software resources provided in the MFP 100 are the same as the hardware resources and the software resources provided in each of the MFPs 100A, 100B, the setting portion 269 sets the setting value of each of the MFP 100A, 100B to the setting value that is the same as the setting value of the MFP 100. Thus, in the case where the same type of a data piece as the data piece received in MFP 100 is received in each of the MFPs 100A, 100B, the process can be executed with the allowing condition satisfied by the operation state. Similarly, in the case where simulating the MFP 100 and changing the setting value based on the data piece received in the MFP 100A, the server 200 sets the setting value of each of the MFPs 100, 100B to the setting value that is the same as the setting value of the MFP 100A. Further, in the case where simulating the MFP 100B and changing the setting value based on the data piece received in the MFP 100B, the server 200 sets the setting value of each of the MFP 100, 100A to the setting value that is the same as the setting value of the MFP 100B.

In the case where the hardware resources and the software resources provided in the MFP 100 are different from the hardware resources and the software resources provided in each of the MFPs 100A, 100B, the setting portion 269 does not set the setting value of each of the MFPs 100A, 100B to the setting value that is the same as the setting value of the MFP 100.

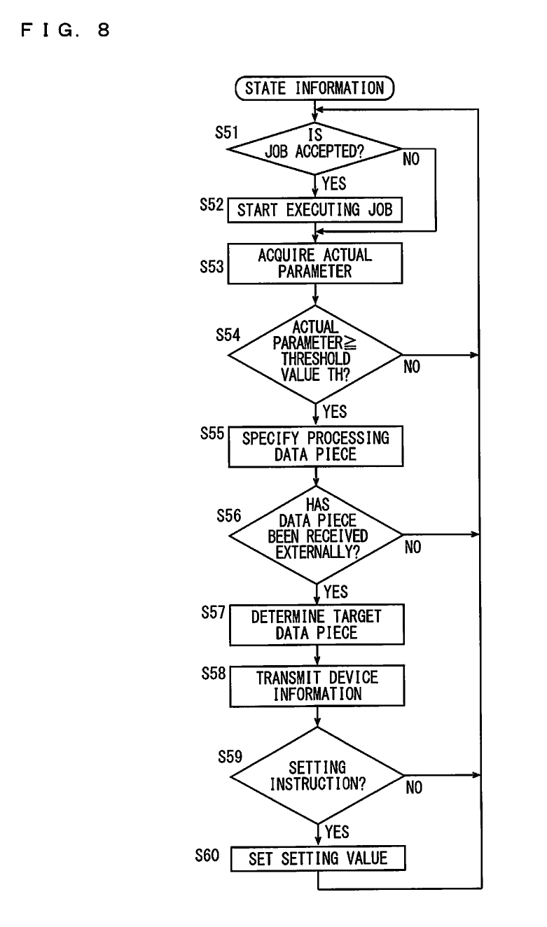

FIG. 8 is a flow chart showing one example of a flow of the state notification process according to one or more embodiments. The state notification process is the function implemented by the CPU 201 when the CPU 171 included in the MFP 100 executes the state notification program stored in the ROM 173, the HDD 113 or the CD-ROM 181. The state notification program is part of the state prediction program. Referring to FIG. 6, the CPU 171 determines whether a job has been received (step S51). If a job has been received, the process proceeds to the step S52. If not, the process proceeds to the step S53. If the communication I/F unit 160 has received a job from an external PC or the like, the CPU 171 accepts the job. Further, in the case where the operation unit 119 accepts an operation of inputting a job by the user, the CPU 171 accepts the job. In the step S52, execution of the job is started, and the process proceeds to the step S53.

In the step S53, the CPU 171 acquires an actual parameter, and the process proceeds to the step S54. The utilization rate at which the CPU 171 is utilized by the task of executing the job is acquired as an actual parameter. In the case where executing a plurality of jobs, the CPU 171 acquires a utilization rate at which the CPU 171 is utilized as an actual parameter for each of the plurality of jobs.

In the step S54, the CPU 171 determines whether the actual parameter is equal to or larger than a threshold value TH. In the case where executing a plurality of jobs, the CPU 171 determines whether an actual parameter of each of the plurality of jobs is equal to or larger than the threshold value TH. If the actual parameter is equal to or larger than the threshold value TH in at least one of the plurality of jobs, the process proceeds to the step S55. If not, the process returns to the step S51. In the step S55, the CPU 171 specifies the data piece to be processed in the job of which the actual parameter is equal to or larger than the threshold value TH as a process data piece.

In the next step S56, the CPU 171 determines whether the process data piece has been received externally. If the process data piece has been received externally, the process proceeds to the step S57. If not, the process returns to the step S51. In the step S57, the CPU 171 determines that the process data piece is the target data piece, and the process proceeds to the step S58.

In the step S58, the CPU 171 generates the device information, and transmits the device information to the server 200. The device information including the job of which an actual parameter is determined in the step S54 to be equal to or larger than the threshold value TH, the target data piece determined in the step S57, the hardware information, the software information and the setting values is generated. Then, the CPU 171 controls the communication I/F unit 160 and transmits the device information to the server 200.

In the next step S59, the CPU 171 determines whether a setting instruction has been received from the server 200. The setting instruction is a command for setting the setting value. If the setting instruction has been received, the process proceeds to the step S60. If not, the process returns to the step S51. In the step S60, the CPU 171 sets the setting value in accordance with the setting instruction, and the process returns to the step S51.

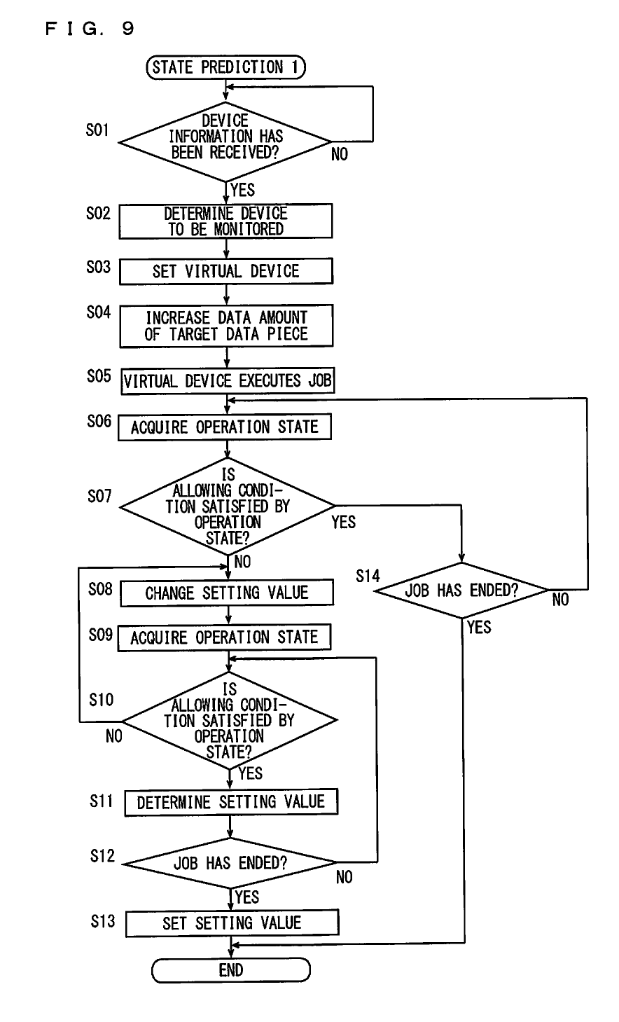

FIG. 9 is a flow chart showing one example of a flow of the state prediction process according to one or more embodiments. The state prediction process is performed by the CPU 201 when the CPU 201 included in the server 200, in accordance with one or more embodiments, executes the state prediction program stored in the ROM 202, the HDD 204 or the CD-ROM 210A. Referring to FIG. 9, the CPU 201 included in the server 200 determines whether the device information has been received. When the communication unit 205 receives the device information from any one of the MFPs 100, 100A, 100B, the CPU 201 determines that the device information has been received. The CPU 201 waits until receiving the device information (NO in the step S01). When the CPU 201 receives the device information (YES in the step 501), the process proceeds to the step S02. The CPU 201 acquires the device information received by the communication 205.

In the step S02, it is determined that the device that has transmitted the device information is to be monitored, and the process proceeds to the step S03. The case where the device information is received from the MFP 100 is described here as an example. In this case, it is determined that the MFP 100 is to be monitored. In the step S03, the CPU 201 sets a virtual device. The CPU 201 simulates the MFP 100 that is to be monitored based on the device information received in the step SOL Specifically, the CPU 201 sets an emulator that emulates the hardware resources defined by the hardware information included in the device information, and sets the software resources defined by the software information included in the device information in a state of being executed by the virtual CPU 301, and sets the setting value included in the device information.

In the next step S04, the CPU 201 increases the data amount of the target data piece, and the process proceeds to the step S05. Specifically, the data amount of the target data piece is increased by the amount defined by a predetermined increase rate. The CPU 201 may increase the data amount of the target data piece by adding the part, corresponding to the data amount defined by the increase rate, of the target data piece to the target data piece.

In the step S05, the CPU 201 causes the virtual device set in the step S03 to execute the job included in the device information received in the step S01. The data piece to be processed in the job is the target data piece of which the data amount is increased in the step S04.

In the step S06, the CPU 201 acquires an operation state of the virtual device, and the process proceeds to the step S07. Specifically, the CPU 201 acquires a utilization rate of the virtual CPU 301 of the virtual device as the operation state. Then, the CPU 201 determines whether the acquired operation state satisfies the allowing condition predetermined for the MFP 100 that is to be monitored. Here, the allowing condition is that the utilization rate of the CPU 171 included in the MFP 100 is equal to or lower than the upper limit value. Therefore, when the utilization rate of the virtual CPU 301 exceeds the upper limit value, the process proceeds to the step S08. If not, the process proceeds to the step S14. In the step S14, the CPU 201 determines whether the execution of the job that has started in the step S05 has ended. If the execution of the job has ended, the process ends. If not, the process returns to the step S06. This is because, in the case where the execution of the job ends with the allowing condition satisfied by the operation state of the virtual CPU 301 that performs the process on the target data piece of which the data amount has been increased, the allowing condition is predicted to also maintain satisfied in the MFP 100.

In the step S08, the setting value is changed. The CPU 201 changes the setting value that influences a load of the task executed by the virtual CPU 301. The setting value may define the priority order of execution of a plurality of tasks, for example. Further, the setting value may be a time-out period that is set for the control of the hardware resources, or the like. Further, the setting value may be a size of a work area of the virtual memory 303. Further, the setting value may be a size of a swap region of each of the virtual memory 303 and the HDD 113A.

In the next step S09, the CPU 201 acquires the operation state of the virtual CPU 301 similarly to the step S06, and the process proceeds to the step S10. In the step S10, the CPU 201 determines whether the allowing condition is satisfied by the operation state of the virtual CPU 301 similarly to the step S07. If the allowing condition is satisfied by the operation state, the process proceeds to the step S11. If not, the process returns to the step S08.

In the step S11, the CPU 201 determines on the setting value set at that time point, and the process proceeds to the step S12. In the step S12, the CPU 201 determines whether execution of the job executed in the step S05 has ended. If the execution of the job has ended, the process proceeds to the step S13. If not, the process returns to the step S10.

In the step S13, the CPU 201 sets the setting value determined in the step S11 in the MFP 100 that is to be monitored, and the process ends. Specifically, the CPU 201 controls the communication unit 205, and transmits a command of setting the setting value to the MFP 100. Further, in the case where the hardware resources and the software resources provided in the MFP 100 are the same as the hardware resources and the software resources provided in each of the MFP 100A, 100B, the setting value determined in the step S11 is set in each of the MFPs 100A, 100B. Specifically, the CPU 201 controls the communication unit 205 and transmits a command of setting the setting value to each of the MFPs 100A, 100B

According to one or more embodiments, the server 200 changes a setting value based on the data piece received in any one of the MFPs 100, 100A, 100B. In the case where two or more of MFPs 100, 100A, 100B receive the data piece that causes an actual parameter to exceed the threshold value, a server 200 in the first modified example analyzes the two or more data pieces, determines the part that is common among the two or more data pieces, and causes the process defined by the job to be performed on common a data piece that is generated when the data amount of the determined part is increased. For example, in the case where a job A and a target data piece A are specified in the MFP 100A, and a job B and a target data piece B are specified in the MFP 100B, the server 200 determines a common part that is common between the target data piece A and the target data piece B, determines the common data that is generated when the data amount of the determined common part is increased, and causes the virtual device to execute the job and process the common data piece. For example, the server 200 causes the virtual device simulating the MFP 100A to execute the job A and process the common data piece. The server 200 may cause the virtual device simulating the MFP 100B to execute the job B and process the common data piece.

In accordance with one or more embodiments, the server 200 functions as the state prediction device, simulates the MFP 100 in operation, increases a load on the virtual device to a load larger than the load on the MFP 100 by causing the virtual device simulating the MFP 100 to process the data piece that is generated when the data amount of the data piece that has been received by the MFP 100 from an external device is increased, and determines whether the allowing condition preset in the MFP 100 is unsatisfied by the operation state of the virtual device on which the increased load is applied. Therefore, it can be predicted before the allowing condition becomes unsatisfied by the operation state of the MFP 100 that the allowing condition becomes unsatisfied by the operation state of the MFP 100.

Further, the MFP 100 specifies the data piece that is predicted to cause an increase in load on the MFP 100 from among the data pieces received from the external device as the target data piece, and the server 200 causes the virtual device to process the data piece that is generated when the data amount of the target data piece specified in the MFP 100 is increased. Therefore, it is not necessary for the server 200 to increase the data amount of all of the data pieces received by the MFP 100 from an external device, and the load caused by the simulation can be reduced as much as possible.

Further, the MFP 100 acquires the actual parameter indicating the load on the CPU 171 included in the MFP 100 for each of one or more processes executed by the MFP 100, and specifies the data piece as the target data piece, the data piece being processed in the process that causes the actual parameter to be in the predetermined prediction state and being received from an external device. Therefore, the target data piece is specified in the MFP 100, so that it is not necessary for the server 200 to simulate the MFP 100 in order to specify the target data piece. Therefore, the load on the CPU 201 included in the server 200 can be reduced as much as possible.

Further, the server 200 simulates the MFP 100 in response to specification of the target data piece in the MFP 100. Thus, the server 200 does not simulate the MFP 100 until the target data piece is specified in the MFP 100, so that the load on the CPU 201 included in the server 200 can be reduced as much as possible.

Further, the MFP 100 acquires the utilization rate of the CPU 171 as an actual parameter, thereby being able to specify the target data piece easily.

Further, in the case where the data amount of the target data piece is increased, the server 200 simulates the MFP 100 that performs only the process on the target data piece of which the data amount is increased. Therefore, it is easy to predict whether the allowing condition is unsatisfied by the operation state of the MFP 100.

Further, in the case where the data amount of the target data piece is increased, the server 200 may simulate the MFP 100 that executes all of a plurality of processes. In this case, it is possible to accurately predict whether the allowing condition is unsatisfied by the operation state of the MFP 100. For example, the server 200 can simulate the event in which the allowing condition is unsatisfied by the operation state of the MFP 100 due to a relative relationship with a task other than the task of processing the target data piece.

Further, in the case where the target data piece is specified in each of two or more of the MFPs 100, 100A, 100B, for example, the case where a target data piece A and a target data piece B are specified in each of the MFPs 100, 100A, the server 200 generates the common data piece by increasing the data amount of the part that is common between the target data piece A and the target data piece B, and causes the virtual device that simulates the MFP 100 or MFP 100A to process the common data piece. Therefore, the server 200 can accurately predict that the allowing condition becomes unsatisfied by the operation state of one of the MFPs 100, 100A.

Further, the server 200 determines that the allowing condition is the condition that the utilization rate of the CPU 171 included in the MFP 100 is equal to or lower than the value defined for the MFP 100 or that the process time from the start to the end of the execution of a predetermined process by the CPU 171 included in the MFP 100 is equal to or lower than the value defined for the MFP 100. Therefore, it is possible to easily predict whether the allowing condition is unsatisfied by the operation state of the MFP 100.

Further, in the case where the allowing condition becomes unsatisfied by the operation state of the virtual device simulating the MFP 100, the server 200 determines the setting value at which the allowing condition is satisfied by the operation state of the virtual device by changing the setting value set in the virtual device, and sets the setting value to the determined setting value in the MFP 100. Therefore, the allowing condition can be made not to become unsatisfied by the operation state of the MFP 100.

Further, in the case where the setting value is determined in any one of the plurality of virtual devices that respectively simulate the MFPs 100, 100A, 100B, the server 200 sets the setting values to the determined setting value in the MFPs 100, 100A, 100B. Therefore, the allowing condition can be made not to become unsatisfied by the operation state of each of the MFPs 100, 100A, 100B.

In the information processing system according to one or more embodiments, each of the MFPs 100, 100A, 100B is allowed to determine the target data piece. In an information processing system according to other embodiments, a server 200 sets each of MFPs 100, 100A, 100B as a device to be monitored, and determines the target data piece for each of the MFPs 100, 100A, 100B by simulating the MFPs 100, 100A, 100B.

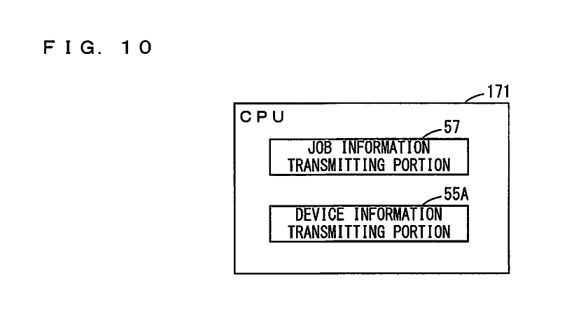

FIG. 10 is a block diagram showing one example of functions of the CPU included in the MFP in accordance with one or more embodiments. The functions shown in FIG. 10 are different from the functions shown in FIG. 6 in that the actual parameter acquiring portion 51 and the target data piece specifying portion 53 are removed, the device information transmitting portion 55 is changed to a device information transmitting portion 55A, and a job information transmitting portion 57 is added.

Referring to FIG. 10, the device information transmitting portion 55A transmits the device information to the server 200 in response to a request from the server 200. The device information referred here includes a model name of the Central Processing Unit provided in the MFP 100, the hardware information relating to the hardware resources installed in the device, the software information relating to the software resources installed in the MFP 100 and the setting values. In response to an input of a job in the MFP 100, the job information transmitting portion 57 transmits the job and the data piece to be processed in the job to the server 200.

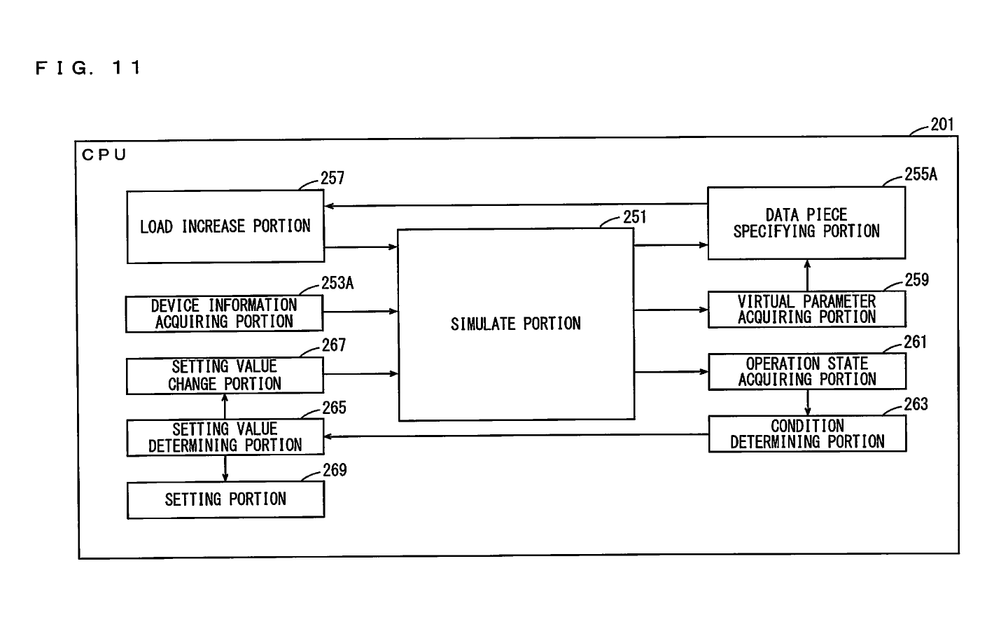

FIG. 11 is a block diagram showing one example of functions of a CPU included in the server in accordance with one or more embodiments. Referring to FIG. 11, differences from the functions shown in FIG. 7 are that the device information acquiring portion 253 and the data piece specifying portion 255 are changed to a device information acquiring portion 253A or a data piece specifying portion 255A, and a virtual parameter acquiring portion 259 is added. Other functions are the same as the functions shown in FIG. 7. A description therefore will not be repeated.

The device information acquiring portion 253A acquires the device information from each of the MPFs 100, 100A, 100B. The case where the device information is acquired from the MFP 100 will be described here as an example. Specifically, the device information acquiring portion 253A controls the communication unit 205, requests the MFP 100 that is to be monitored to transmit the device information, and receives the device information transmitted by the MFP 100. The device information includes a model name of a Central Processing Unit provided in the device, the hardware information relating to the hardware resources installed in the device, the software information relating to the software resources installed in the device and a setting value. The setting value influences a load of a task executed by the CPU 171 included in the MFP 100 that is to be monitored. For example, the setting value defines the priority order of the execution of a plurality of tasks. In the case where acquiring the device information, the device information acquiring portion 253 outputs the device information to the simulate portion 251. The simulate portion 251 sets the virtual device that simulates the MFP 100 based on the device information.

When starting the execution of a job, the MFP 100 that is to be monitored transmits the job and the data piece to be processed in the job. Thus, when the communication unit 205 receives the job and the data piece transmitted by the MFP 100, the device information acquiring portion 253A acquires the received job and a data piece. In the case where acquiring the job and the data piece, the device information acquiring portion 253 outputs the job and the data piece to the simulate portion 251. The simulate portion 251 causes the virtual device simulating the MFP 100 to perform the process defined in the job on the data piece.

The virtual parameter acquiring portion 259 acquires a virtual parameter that indicates a load applied by each job on the virtual device, the virtual device including the simulate portion 251 simulating the MFP 100 that is to be monitored. The virtual parameter indicating the load on the virtual device is a value defined for each job. Specifically, the virtual parameter indicates the load on the virtual CPU 301 in the case where the virtual CPU 301 performs the process defined by the job on the data piece to be processed in the job. Therefore, the virtual parameter is the value corresponding to the data piece to be processed in the job. Here, the virtual parameter is a utilization rate at which the virtual CPU 301 is utilized by each task executed by the virtual CPU 301. The utilization rate of the virtual CPU is the proportion of the time required for the virtual CPU 301 to execute a task of executing a job. The virtual parameter is not limited to the utilization rate of the virtual CPU 301 and may be defined for the data piece to be processed in the job. The utilization rate of the virtual memory 303, the number of swaps in which a data piece is transferred between the swap regions of the virtual memory 303 and the HDD 113A, for example, may be used as the virtual parameters. The virtual parameter acquiring portion 259 outputs the virtual parameter that is acquired for each job to the data piece specifying portion 255A.

The data piece specifying portion 255A specifies the data piece that is predicted to cause an increase in load on the virtual CPU 301 as the target data piece. Specifically, the data piece specifying portion 255A specifies the data piece to be processed in the process that causes the virtual parameter to be is in a predetermined prediction state as the target data piece. Here, the data piece specifying portion 255A compares the virtual parameter to a predetermined threshold value. In the case where the job that causes the virtual parameter to be equal to or larger than the threshold value is present, the data piece specifying portion 255A specifies the data piece to be processed in the job as the data piece that is predicted to cause an increase in load on the virtual CPU 301. Further, the data piece specifying portion 255A specifies the data piece as the target data piece on the condition that the data piece that is predicted to cause an increase in load on the virtual CPU 301 is the data piece received from an external device.

The threshold value is a predetermined value of a load on the CPU 171 included in the MFP 100 to be monitored. The threshold value is a value at which an error does not occur in each of all of the tasks executed by the CPU 171. The utilization rate of the CPU 171 may increase in the case where the same process is unnecessarily and repeatedly executed in a certain task, for example, and the threshold value may be a value at which unnecessary repetition of execution of the same process by the CPU 171 is detectable. In this case, the threshold value is defined by the task of executing the job. The threshold value may be an increase rate of the utilization rate of the CPU 171. Further, when the utilization rate at which the CPU 171 is utilized by the first task is increased, the utilization rate at which the CPU 171 is utilized by the second task is lowered relatively. In this case, there may be a delay with the process of the second task, and a time-out error or the like may occur. The threshold value may be the value at which the state of the CPU 171 of the first task is detectable before a time-out error occurs in the process of the second task. In this case, the threshold value is defined by a relative relationship with another task of executing another job. The upper limit of the utilization rate of the CPU 171 that is allowed for one task may be predetermined as the threshold value. This threshold value can be obtained by an experiment. The threshold value may be an increase rate of the utilization rate of the CPU 171.

The target data piece specified by the data piece specifying portion 255A is received externally of the MFP 100. Further, the target data piece may cause an error when the CPU 171 continues to execute the process in the MFP 100. The data piece received from the outside of the MFP 100 includes the data piece that is received externally and stored in the HDD 113.

Because the load increase portion 257 increases a data amount of target data piece, the simulate portion 251 causes a virtual device to perform the process defined by a job on the target data piece of which the data amount has been increased. In the server 200, in accordance with one or more embodiments, the CPU 201 allows the virtual device to execute all of the jobs executed by the MFP 100. Therefore, in the case where the MFP 100 executes two or more jobs at the same time, the CPU 201 causes the virtual device to also execute two or more jobs at the same time. At this time, the load increase portion 257 increases the data amount of only the target data piece, and the CPU 201 causes the corresponding job to be executed.

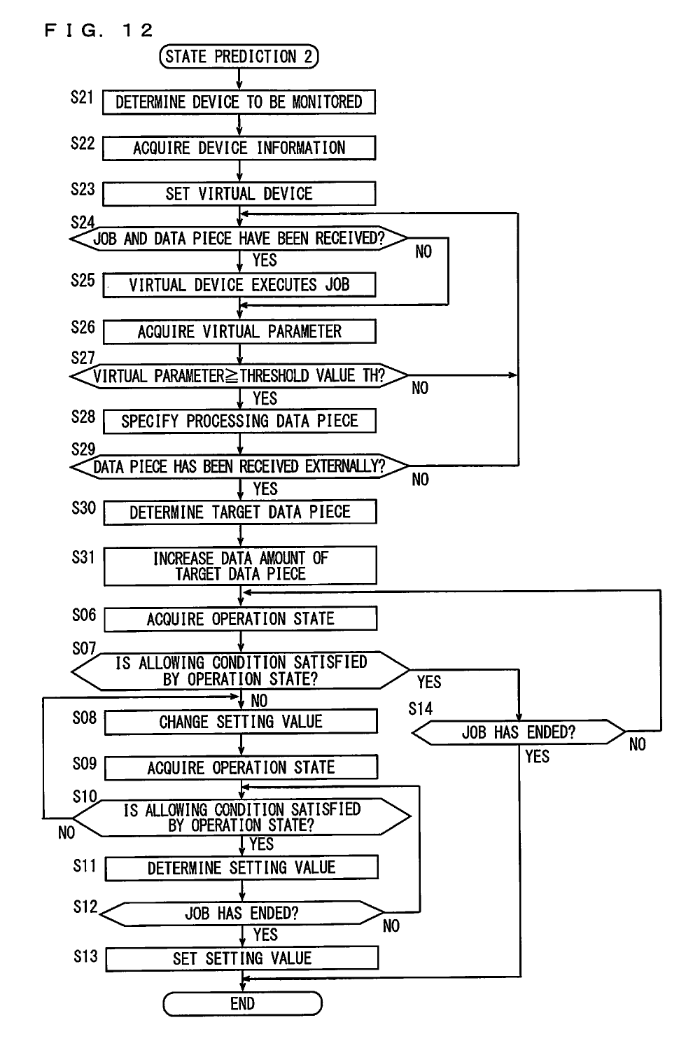

FIG. 12 is a flow chart showing one example of a flow of an operation assistance process in accordance with one or more embodiments. Referring to FIG. 12, a difference from the operation assistance process shown in FIG. 9 is that the steps S21 to S31 are performed instead of the steps S01 to S05. The other processes are the same as the processes shown in FIG. 9. A description thereof will not be repeated.

The CPU 201 included in the server 200 determines a device to be monitored in the step S21. The CPU 201 determines that a predetermined device is to be monitored. The case where the MFPs 100, 100A, 100B are determined as devices to be monitored will be described here as an example. In the next step S22, the device information is acquired from each of the MFPs 100, 100A, 100B that are to be monitored. Then, in the step S23, the CPU 201 sets the virtual device that simulates each of the MFPs 100, 100A, 100B based on the device information acquired from each of the MFPs 100, 100A, 100B that are to be monitored.

The process that comes after the step S24 is performed on each of the MFPs 100, 100A, 100B that are to be monitored. As for the process that comes after the step S24, the process performed on the MFP 100, that is to be monitored, will be described here as an example. In the step S24, whether a job and a data piece have been received from the MFP 100 is determined. If the job and the data piece are received, the process proceeds to the step S25. If not, the process proceeds to the step S26. In the step S25, the CPU 201 causes the virtual device simulating the MFP 100 to execute the job received in the step S24 and process the data piece received in the step S24, and the process proceeds to the step S26.

In the step S26, the CPU 201 acquires a virtual parameter, and the process proceeds to the step S27. The utilization rate of the virtual CPU 301 of the virtual device simulating the MFP 100 is acquired as the virtual parameter. In the case where a plurality of jobs are under execution by the virtual CPU 301, the utilization rate of the virtual CPU 301 is acquired as the actual parameter for each of the plurality of jobs.

In the step S27, the CPU 201 determines whether the virtual parameter is equal to or larger than a threshold value TH. In the case where a plurality of jobs are under execution, whether the virtual parameter is equal to or larger than the threshold value TH is determined for each of the plurality of jobs. When the virtual parameter is equal to or larger than the threshold value TH in at least one of the plurality of jobs, the process proceeds to the step S28. If not, the process returns to the step S24. In the step S28, the CPU 201 specifies the data piece to be processed in the job that causes the virtual parameter to be equal to or larger than the threshold value TH as a process data piece.

In the step S29, the CPU 201 determines whether the process data piece has been received externally by the MFP 100 that is to be monitored. If the process data has been received externally, the process proceeds to the step S30. If not, the process returns to the step S24. In the step S30, the process data piece is determined as the target data piece, and the process proceeds to the step S31.

In the step S31, the CPU 201 increases the data amount of the target data piece, and the process proceeds to the step S06. The CPU 201 increases the data amount of the target data piece being processed by the virtual device simulating the MFP 100, and executes the job.

The server 200, in accordance with one or more embodiments, changes a setting value based on the data piece received by any one of virtual devices that respectively simulate the MFPs 100, 100A, 100B. In the case where two or more virtual devices that respectively simulate MFPs 100, 100A, 100B receive the data piece that causes a virtual parameter to exceed a threshold value, the server 200 in the second modified example analyzes the two or more data pieces, determines the part that is common between the two or more data pieces, generates the common data piece by increasing the data amount of the determined part, and causes the process defined by the job to be performed on the common data piece. For example, in the case where a job A and a target data piece A are specified by the virtual device simulating the MFP 100A, and a job B and a target data piece B are specified by the virtual device simulating the MFP 100B, the server 200 determines the common part that is common between the target data piece A and the target data piece B, and causes the virtual device to execute a job and process the common data piece that is generated when the data amount of the determined common part is increased. For example, the server 200 causes the virtual device simulating the MFP 100A to execute the job A and process the common data piece that is generated when the data amount of the common part is increased. The server 200 may allow the virtual device simulating the MFP 100B to execute the job B and process the common data piece that is generated when the data amount of the common part is increased.

The server 200, in accordance with one or more embodiments, causes the virtual device to execute all of the plurality of processes under execution by the MFP 100, acquires the virtual parameter indicating a load on the virtual device for each of one or more processes executed by the virtual device, and specifies the data piece to be processed in the process that causes the virtual parameter to be in the predetermined prediction state as the target data piece. Therefore, the server 200, in accordance with one or more embodiments, can reduce the load on the CPU 171 included in the MFP 100 as much as possible in addition to the effects of the server 200 according to one or more other embodiments.

Further, because the CPU 201 acquires the utilization rate of the virtual CPU 301 of the virtual device as a virtual parameter, the target data piece can be specified easily.

While the server 200 is shown as one example of the state prediction device in one or more of the above-mentioned embodiments, it is needless to say that other embodiments of the present invention can be specified as a state prediction method of causing the server 200 to execute the state prediction process shown in FIGS. 9 and 12, and a state prediction program for causing the CPU 201 of the server 200 to perform the state prediction method.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A state prediction device comprising a hardware processor, wherein the hardware processor:
simulates an information processing apparatus in operation with a virtual device;
increases a load on the virtual device to a load larger than a load on the information processing apparatus by causing the virtual device to process a data piece, wherein the data piece is generated with a larger data amount than that of a second data piece received externally by the information processing apparatus; and
determines whether an allowing condition that is preset in the information processing apparatus is unsatisfied by an operation state of the virtual device while the increased load is applied.

2. The state prediction device according to claim 1, wherein the hardware processor further:
specifies a target data piece that is predicted to cause an increase in load on the information processing apparatus from data pieces externally received by the information processing apparatus; and
causes the virtual device to process a third data piece, wherein the third data piece is generated with a larger data amount than that of the target data piece.

3. The state prediction device according to claim 2, wherein the information processing apparatus
acquires an actual parameter indicating a load on the information processing apparatus for each of one or more processes executed by the information processing apparatus, and
specifies a fourth data piece that is to be processed in a process causing the acquired actual parameter to be in a predetermined prediction state and has been received externally, as the target data piece.

4. The state prediction device according to claim 2, wherein the hardware processor further simulates the information processing apparatus in response to specification of the target data piece.

5. The state prediction device according to claim 3, wherein the actual parameter is a utilization rate of a Central Processing Unit included in the information processing apparatus.

6. The state prediction device according to claim 2, wherein the hardware processor further:
acquires a virtual parameter indicating a load on the virtual device for each of one or more processes executed by the virtual device; and
specifies a fifth data piece, that is to be processed in a process causing the virtual parameter to be in a predetermined prediction state and has been received externally, as the target data piece, the virtual parameter being acquired with all of a plurality of processes under execution by the information processing apparatus executed by the virtual device.

7. The state prediction device according to claim 6, wherein the virtual parameter is a utilization rate of a central processing unit included in the virtual device.

8. The state prediction device according to claim 2, wherein the hardware processor, when the data amount of the target data piece is increased, further causes the virtual device to perform a process only on the target data piece of which the data amount has been increased.

9. The state prediction device according to claim 2, wherein the hardware processor, when the data amount of the target data piece is increased, further causes the virtual device to execute all of a plurality of processes under execution by the information processing apparatus.

10. The state prediction device according to claim 2, wherein
the plurality of information processing apparatus are present, and
the hardware processor, when the target data piece is specified in each of two or more of the plurality of information processing apparatuses, further causes the virtual device to process a common data piece, wherein the common data piece is generated with a larger data amount than that of a data part that is common between two or more target data pieces.

11. The state prediction device according to claim 1, wherein the allowing condition is either:
a condition that a utilization rate of a central processing unit included in the information processing apparatus is equal to or lower than a value defined for the information processing apparatus; or
a condition that a processing time period from a start to an end of a predetermined process executed by the central processing unit included in the information processing apparatus is equal to or shorter than a value that is predetermined for the information processing apparatus.

12. The state prediction device according to claim 1, wherein when the allowing condition preset in the information processing apparatus is unsatisfied by an operation state of the virtual device, the hardware processor further:
determines a setting value at which the allowing condition is satisfied by the operation state of the virtual device by changing a setting value set in the virtual device; and
sets a setting value in the information processing apparatus to the determined setting value.

13. The state prediction device according to claim 12, wherein
the plurality of information processing apparatuses are present, and
the hardware processor, when the setting value at which the allowing condition is satisfied is determined for the virtual device simulating any one of the plurality of information processing apparatuses, further sets a setting value in each of the plurality of information processing apparatuses to the determined setting value.

14. A state prediction method performed by a state prediction device, the state prediction method comprising:
simulating an information processing apparatus in operation with a virtual device;
increasing a load on the virtual device to a load larger than a load on the information processing apparatus by causing the virtual device to process a data piece, wherein the data piece is generated with a larger data amount than that of a second data piece received externally by the information processing apparatus; and
determining whether an allowing condition preset in the information processing apparatus is unsatisfied by an operation state of the virtual device on which an increased load is applied.

15. A non-transitory computer-readable recording medium storing a state prediction program executed by a computer controlling a state prediction device, the state prediction program causing the computer to:
simulate an information processing apparatus in operation with a virtual device;
increase a load on the virtual device to a load larger than a load on the information processing apparatus by causing the virtual device to process a data piece, wherein the data piece is generated with a larger data amount than that of a second data piece received externally by the information processing apparatus; and
determine whether an allowing condition preset in the information processing apparatus is unsatisfied by an operation state of the virtual device on which an increased load is applied.

16. The non-transitory computer-readable recording medium according to claim 15, wherein the non-transitory computer-readable recording medium storing the state prediction program further causes:
the computer to specify a target data piece that is predicted to cause an increase in load on the information processing apparatus from among data pieces received externally by the information processing apparatus; and
the virtual device to process a third data piece, wherein the third data piece is generated with a larger data amount than that of the target data piece.

17. The non-transitory computer-readable recording medium according to claim 16, wherein
the plurality of information processing apparatuses are present, and
the non-transitory computer-readable recording medium storing the state prediction program, when the target data piece is specified in each of two or more of the plurality of information processing apparatuses, further causes a virtual device simulating any one of the plurality of information processing apparatuses to process a common data piece, wherein the common data piece is generated with a larger data amount than that of a data part that is common between the two or more target data pieces.

18. The non-transitory computer-readable recording medium according to claim 15, wherein
the non-transitory computer-readable recording medium storing the state prediction program, when the allowing condition that is preset in the information processing apparatus is unsatisfied by an operation state of the virtual device further causes:
the computer to determine a setting value at which the allowing condition is satisfied by the operation state of the virtual device by changing a setting value set in the virtual device; and
the information processing apparatus to set a setting value to the determined setting value.

19. The non-transitory computer-readable recording medium according to claim 18, wherein
the plurality of information processing apparatuses are present, and
the non-transitory computer-readable recording medium storing the state prediction program, when a setting value at which the allowing condition is satisfied is determined for the virtual device simulating any one of the plurality of information processing apparatuses, further causes each of the plurality of information processing apparatus to set a setting value to the determined setting value.
